(19) United States
(12) Patent Application Publication
(10) Pub. No.: US 2025/0005867 A1
(43) Pub. Date: Jan. 2, 2025

(54) ASYMMETRICAL XR NAVIGATION FOR AUGMENTING OBJECTS OF INTEREST IN EXTENDED REALITY STREAMING

(71) Applicant: Adeia Guides Inc., San Jose, CA (US)

(72) Inventors: Jennifer Reynolds, Sugar Hill, GA (US); Christopher Phillips, Hartwell, GA (US); Reda Harb, Tampa, FL (US)

(21) Appl. No.: 18/214,776

(22) Filed: Jun. 27, 2023

(51) Int. Cl. G06T 19/00

(52) U.S. Cl. CPC G06T 19/006

(57) ABSTRACT

Systems and methods are described for asymmetrical XR application for efficient navigation. In particular, the XR application may generate for display, on a client device, a graphical representation of a 3D location. The XR application may then receive an input, via the client device, identifying a portion of the graphical representation (e.g., this may be from 2D coordinates). The XR application may access a mapping between objects in the graphical representation (e.g., 2D coordinates) of the 3D location and 3D objects in the 3D location. Then based on the mapping, the XR application may identify a correspondence between a graphical object in the portion of the graphical representation and a 3D object in the 3D location. The XR application may transmit a signal to cause an XR device at the 3D location to generate for display an augmentation for the 3D object in the 3D location.

### BACKGROUND

This disclosure is directed to systems and methods for asymmetrical extended-reality (XR) navigation.

### SUMMARY

XR streaming provides users with an immersive interface that may be implemented via a full virtual reality (VR) 3D environment, augmented reality (AR) having a virtual 3D overlay on top of a normal reality medium, and/or a mixed reality (MR) having a real-world environment incorporated into a computer-generated environment. These XR technologies of AR/VR/MR provide for richer and more immersive experiences compared to a 2D experience that may be provisioned via consumer electronics such as smartphones, tablets, and personal computers without the integration of XR. For example, a 2D display may be used to provide a graphical representation of a real 3D space (e.g., a 2D video feed of a park, or polygon generated model of a park). However, even with these graphical representations, there are user experience deficiencies with respect to communication between the real 3D space and the 2D graphical representation, such as not being able to hone in on specific objects of interest immediately. Because adoption of XR is not yet pervasive, there remains a need for integrating conventional interfaces, such as 2D or 3D interfaces, with XR interfaces in order to provide a fluid user experience and mitigating the user experience differences in these asymmetrical technologies.

In one approach, user devices that are 2D-enabled may utilize unrelated communication mediums, such as voice calls, in order to interact with the XR device to specify an object of interest. For example, if an XR host is streaming at a public park, and a user using a 2D device is receiving a 2D feed of the XR point of view, the user may be able to interact with an XR host for further exploration of a landmark that was shown previously on the 2D graphical representation. However, it is apparent that the XR host will have to determine which landmark the user is referring to (e.g., “Did you mean that mountain, or the other mountain?”), and this may be an inefficient process to determine which is the landmark of interest to the user.

To overcome these problems, systems and methods are provided herein for an asymmetrical XR Application for efficient navigation between different graphical representations. In particular, the XR application may create a graphical representation of a real 3D location on a client device (e.g., a 2D rendering point of view perspective of a park tour on a 2D tablet device). The XR application may then receive an input by which the client identifies a portion of the 2D graphical representation (e.g., the user selects an apple tree via touchscreen).

The XR application accesses a mapping between both of the different 2D and 3D graphical representations of the park. For example, the touchscreen input associated with the apple tree object in 2D, which has its own 2D coordinates, is mapped to the 3D graphical representation in spatial coordinates for the XR application to map the apple tree in the 3D space. Then, based on the mapping, the XR application may identify a correspondence between the selected input (e.g., the apple tree object in 2D) and a 3D object in the 3D location (e.g., the corresponding apple tree object in 3D). In this way, there is no ambiguity in terms of which object of interest is selected, despite the graphical representations being 2D for the tablet, and 3D XR for an XR host giving an AR park tour. The XR application may then augment the corresponding 3D object in the 3D location (e.g., the apple tree may be highlighted for the XR host to elaborate further upon on the park tour). In this way, the XR application provides for an asymmetrical efficient navigation between different graphical representations of an environment. The apple tree seen on the 2D tablet is immediately selected and highlighted for the XR host to interact with and provide further information about on requests from the 2D user.

In some aspects of this disclosure, the graphical representation may include a 2D graphical representation of the 3D location on the client device. In this aspect, the XR application may identify a correspondence between the graphical object in the portion of the 2D graphical representation and the 3D object in the 3D location based on the mapping. For example, if the client device was a 2D tablet interacting with an XR 3D host, the XR application would identify a correspondence between the graphical object in the portion of the 2D graphical representation and the 3D object in the 3D location based on the mapping.

In other aspects of this disclosure, the graphical representation may include a 3D graphical representation of the 3D location on the client device. In this aspect, the XR application may identify a correspondence between the graphical object in the portion of the 3D graphical representation and the 3D object in the 3D location.

In some embodiments, the XR application may create the graphical representation of the 3D location on an XR device. This graphical representation of the 3D location may be stored in memory. The XR application may receive an input from the client device, requesting the graphical representation of the 3D location. In response to this request, the XR application may retrieve the graphical representation of the 3D location from the memory and provide the graphical representation of the 3D location to the client device, fulfilling the request. In some embodiments of this disclosure, the XR application may record the augmentation for the 3D object in the 3D location that is generated for display in memory. The XR application may receive an input from a client device requesting the augmentation for the 3D object in the 3D location. In response to this request, the XR application may retrieve the augmentation for the 3D object in the 3D location from the memory, and provide the augmentation for the 3D object in the 3D location to the client device to fulfill the request. In this way, the XR application can provide previously recorded interactions to future requests on demand without the augmentation needing to be “live” at every client request.

In some embodiments, the XR application receives a set of coordinates from the client device on a portion of the graphical representation. Based on these coordinates, the XR application identifies a correspondence between a graphical object at the set of coordinates and a 3D object in the 3D location. The XR application may then transmit a second signal to cause the XR device at the 3D location to generate for display the augmentation for the 3D object in the 3D location. In some variants, the mapping may receive a plurality of sets of coordinates from a plurality of client devices. The XR application may then determine a coordinate of interest, identifying a correspondence between a graphical object at the coordinate of interest and a 3D object in the 3D location. The XR application may then transmit a third signal to cause the AR device at the 3D location to generate for display the augmentation for the 3D object in the 3D location. In this way, the XR host may be able to address the most interesting aspects of the 3D location, whether the requests be express (e.g., via client device express request) or implied (e.g., receiving eye gaze data from a plurality of client devices to show areas of most interest).

### BRIEF DESCRIPTION OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and should not be considered limiting of the breadth, scope, or applicability of these concepts. It should be noted that for clarity and ease of illustration, these drawings are not necessarily made to scale.

FIG. 1 shows an illustrative scenario in which a 2D user device is interacting with an XR host during a virtual tour, in accordance with some embodiments of this disclosure.

FIG. 2 shows an illustrative scenario in which an XR device is scanning a 3D environment for objects, in accordance with some embodiments of this disclosure.

FIG. 3 shows an illustrative diagram for mapping 3D objects in a 3D environment to 2D objects in a 2D environment, in accordance with some embodiments of this disclosure.

FIG. 4 shows an illustrative diagram of a 3D scan of a real estate dwelling, in accordance with some embodiments of this disclosure.

FIG. 5 shows an illustrative diagram of a 2D graphical representation of a home tour, in accordance with some embodiments of this disclosure.

FIG. 6 shows an illustrative diagram of a 2D graphical representation of a user interacting with an XR host, in accordance with some embodiments of this disclosure.

FIG. 7 shows additional illustrative diagrams of a 2D graphical representation of a user interacting with an XR host, in accordance with some embodiments of this disclosure.

FIG. 8 shows further additional illustrative diagrams of a 2D graphical representation of a user interacting with an XR host, in accordance with some embodiments of this disclosure.

FIG. 9 shows an illustrative diagram of a 2D graphical representation of a casino, in accordance with some embodiments of this disclosure.

FIG. 10A shows an illustrative flow diagram of an XR host, cloud server, and 2D client device, in accordance with some embodiments of this disclosure.

FIG. 10B shows an illustrative flow diagram of an XR host, cloud server, and 2D client device, 3D client device, and multiple 3D cameras, in accordance with some embodiments of this disclosure.

FIG. 11A shows an illustrative flow diagram of an XR host and 2D client device in a peer-to-peer configuration, in accordance with some embodiments of this disclosure.

FIG. 11B shows an illustrative flow diagram of an XR host and 3D client device in a peer-to-peer configuration, in accordance with some embodiments of this disclosure.

FIG. 11C shows an illustrative flow diagram of another XR host and 3D client device in a peer-to-peer configuration, in accordance with some embodiments of this disclosure.

FIG. 12 shows illustrative user equipment devices, in accordance with some embodiments of this disclosure.

FIG. 13 shows illustrative systems, in accordance with some embodiments of this disclosure.

FIG. 14 is a flowchart of a detailed illustrative process for transmitting a signal to cause an AR device at the 3D location to generate for display an augmentation for the 3D object in the 3D location, in accordance with some embodiments of this disclosure.

FIG. 15 is a flowchart of a detailed illustrative process for providing the augmentation for the 3D object in the 3D location to the client device, in accordance with some embodiments of this disclosure.

FIG. 16 is a flowchart of a detailed illustrative process for transmitting a second signal to cause the AR device at the 3D location to generate for display the augmentation for the 3D object in the 3D location, in accordance with some embodiments of this disclosure.

FIG. 17 is a flowchart of a detailed illustrative process for transmitting a third signal to cause the AR device at the 3D location to generate for display the augmentation for the 3D object in the 3D location, in accordance with some embodiments of this disclosure.

### DETAILED DESCRIPTION

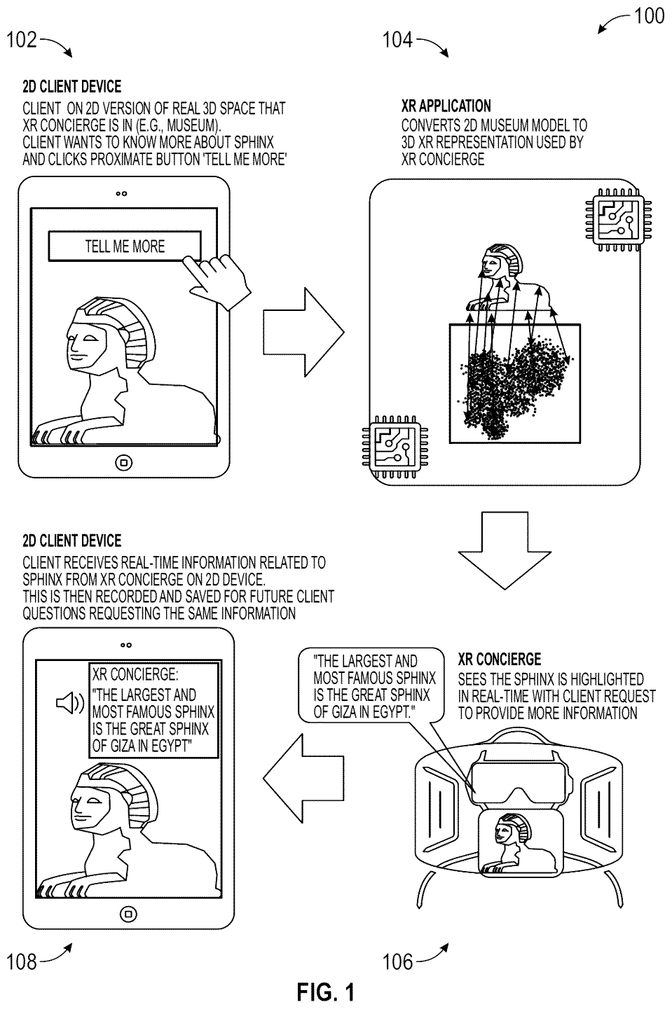

FIG. 1 shows an illustrative scenario 100 in which a 2D user device is interacting with an XR host during a virtual tour, in accordance with some embodiments of this disclosure. In this exemplary embodiment, a 2D client device (e.g., a tablet device) is viewing a museum tour via the device at 102. An XR application may be implemented that may be a combination of software and/or hardware to perform asymmetrical efficient navigation between different graphical representations on different devices. In some embodiments, the XR application may be implemented in a cloud server configuration having communication means via an input/output (I/O) path between client devices and 3D devices (e.g., XR devices). In some embodiments, the XR application may be implemented within one or both of the client devices and the 3D devices. In some embodiments, the XR application may be implemented on any combination of separate hardware, a client device, and a 3D device. The XR application may generate for display on a client device a graphical representation of a 3D location. In the present example, the XR application generates a 2D graphical representation of the museum on the tablet device. The graphical representation may be generated by various rendering techniques. In one embodiment, a 2D graphical representation is generated by providing a camera feed of the 3D environment. In one embodiment, the graphical representation is generated by constructing a rendered 3D environment based on graphical capture (e.g., by 3D cameras). In one embodiment, a 2D bird's-eye view of an environment is approximated using reference information (e.g., maps, architectural drawings, crowdsourced information). In some embodiments, the XR application creates a 2D polygon model of the 3D location based on 2D polygonal rendering from geometric information captured from the 2D and/or 3D cameras. In some embodiments, the XR application may implement a predefined spatial boundary for rendering (e.g., calculated visible line of sight, pre-determined distance of one-mile radius, limit of room size within building, etc.).

The XR application may receive an input from the client device, identifying a portion of the graphical representation. In FIG. 1, at 102, the XR application may receive an input from the client device (e.g., a touchscreen selection) during the museum tour and select a button “TELL ME MORE” with respect to a 2D graphical representation of a sphinx from the actual museum. In some embodiments, the input may include, but is not limited to: a touchscreen input, an eye gaze on an XR device, an audio cue, a motion gesture, a hardware input via controller (e.g., joystick, control device, mouse, etc.), or a typed instruction via keyboard.

The XR application may access a mapping between objects in the graphical representation of the 3D location and 3D objects in the 3D location. In FIG. 1, at 104, the XR application accesses a mapping between the tablet 2D representation of the museum and the 3D XR representation used by a XR concierge providing a live museum tour. In particular, the portion, which includes the sphinx, is mapped into a point cloud comprising a plurality of coordinates that may be converted to any form of metadata to be stored efficiently. The XR application would receive full object point clouds and metadata along with a mapping function to translate between said cloud spatial coordinates and the current 2D video viewport coordinates from the client device. In some embodiments, the mapping function may be updated every time the XR headset moves or rotates. In some embodiments, the XR application receives 2D polygon coordinates corresponding to all currently visible objects to be transmitted across the network in the 2D graphical representation from a 2D client device. In some embodiments, the XR application receives 3D spatial coordinates corresponding to all currently visible objects to be transmitted across the network in the 3D graphical representation from a 3D client device. In some embodiments, the mapping is stored in one or more databases keeping disparate datasets for each graphical representation and a hash table (or similar analogue) in which one or more coordinates within graphical representation correspond to the other graphical representation. For example, a hash table may indicate that a 2D museum graphical representation corresponds to a 3D museum XR graphical representation. In some embodiments, the XR application may access mapping that is stored locally within the XR application. In some embodiments, the XR application may access mapping that is stored remote from the XR application; for example, a cloud-based server may store the mapping. In some embodiments, the XR application may access the mapping from the client device. In some embodiments, the XR application may, based on the mapping, identify a correspondence between the graphical object in the portion of the 2D graphical representation (e.g., what is seen on the tablet) and the 3D object in the 3D location (e.g., the 3D graphical representation on the XD device). Although the example used above includes a 2D representation of a museum, the client device may be a 3D device, such as an AR headset, and consequently a 3D representation of a museum may also be used at the client device.

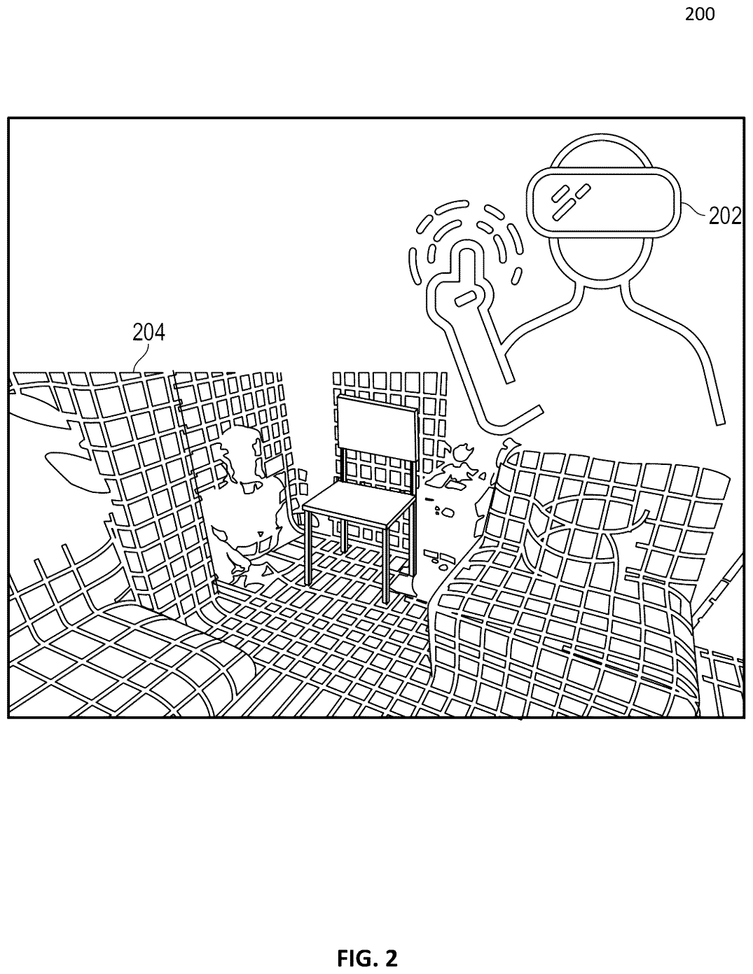

FIG. 2 shows an illustrative scenario 200 in which an XR device is scanning a 3D environment for objects, in accordance with some embodiments of this disclosure. For example, this may emulate an XR concierge using an AR/VR headset to map a 3D environment (e.g., museum). The XR application takes this scanned information to generate a corresponding graphical representation for the client device (e.g., may be 2D or 3D depending on the client device). In some embodiments, the XR device may scan a 3D environment using LIDAR, simultaneous localization and mapping (SLAM) and/or similar systems.

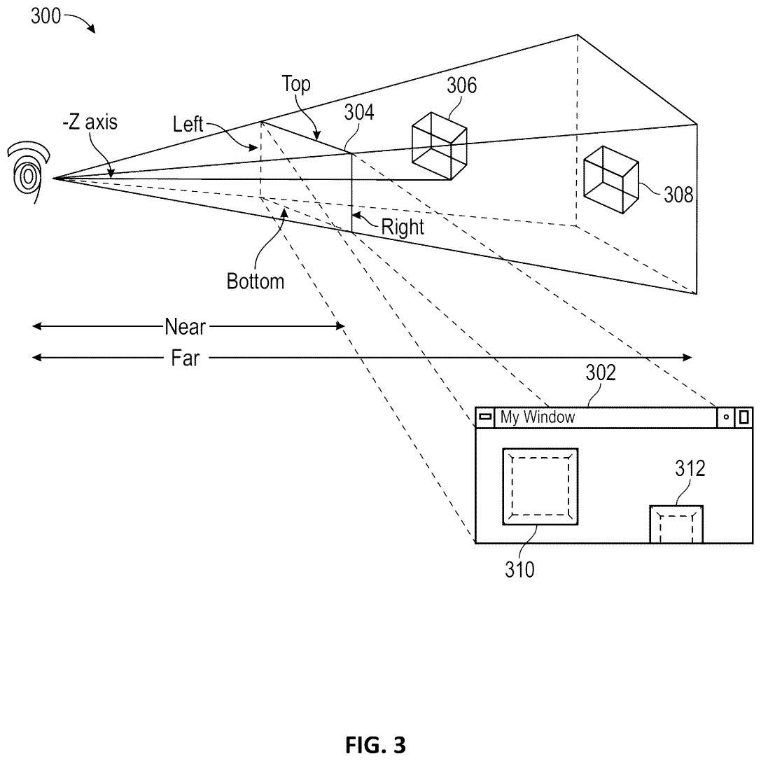

FIG. 3 shows an illustrative diagram 300 for mapping 3D objects in a 3D environment to 2D objects in a 2D environment, in accordance with some embodiments of this disclosure. For example, the 2D plane 302 shown in the bottom right of the figure corresponds to the 3D plane of 304. The two cubes at altered distances 306, 308 in the 3D plane correspond to their 2D graphical representations in the 2D plane 310, 312. The XR application may map an environment to various degrees depending on XR application configuration. In some embodiments, the XR application maps the full graphical representation and all objects corresponding within the representation. In some embodiments, the XR application maps only a subset of the graphical representation. For example, the XR application may map only objects within a determined point of view, a predetermined or configurable radius of distance, etc. The XR application may update the mapping on reconfiguration of the subset parameters, and/or if the point of view is altered (e.g., real-time mapping). In some embodiments, the XR application maps only those objects that are selected by one or more client devices. For example, the user of a client device may click on the sphinx, and the XR application would only then map the sphinx between both graphical representations.

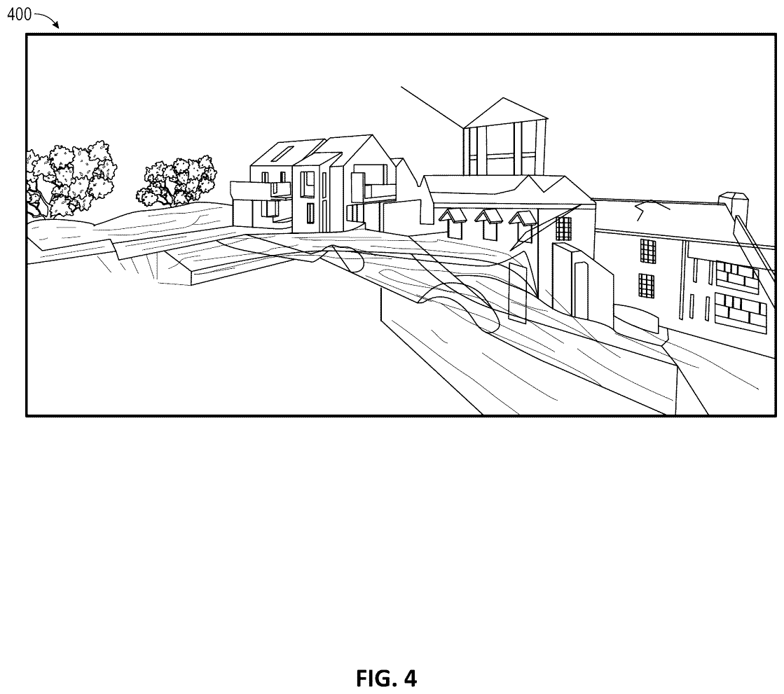

FIG. 4 shows an illustrative diagram 400 of a 3D scan of a real estate dwelling, in accordance with some embodiments of this disclosure. This is an example of a whole room scanned in 3D. The XR application may use this type of 3D VR mapping for VR clients to demonstrate the entire dwelling, specific rooms, etc. The scan may be captured from a 3D camera. In one scenario, the user of the client device may use a VR headset to place themselves in the 3D space, while the XR concierge would be live in the real-world dwelling using an AR overlay with an AR headset. In some embodiments, the client device may be able to walk through the dwelling in a 3D interface (e.g., VR).

The XR application may, based on the mapping, identify a correspondence between a graphical object in the portion of the graphical representation and a 3D object in the 3D location. In FIG. 1, at 104, the XR application identifies the sphinx from the 2D graphical representation for which the “TELL ME MORE” button was in proximate distance. In some embodiments, the XR application may determine the correspondence of the graphical object by determining the object proximate to the touchscreen input selected. In some embodiments, the XR application may determine the correspondence of the graphical object by determining an object of high interest based on a previous recognized object within the portion of the graphical representation. In some embodiments, the XR application may determine the correspondence of the graphical object by determining a correspondence between an instruction received from the client device (e.g., a typed instruction regarding “sphinx”) and any objects within the portion that relate to the instruction.

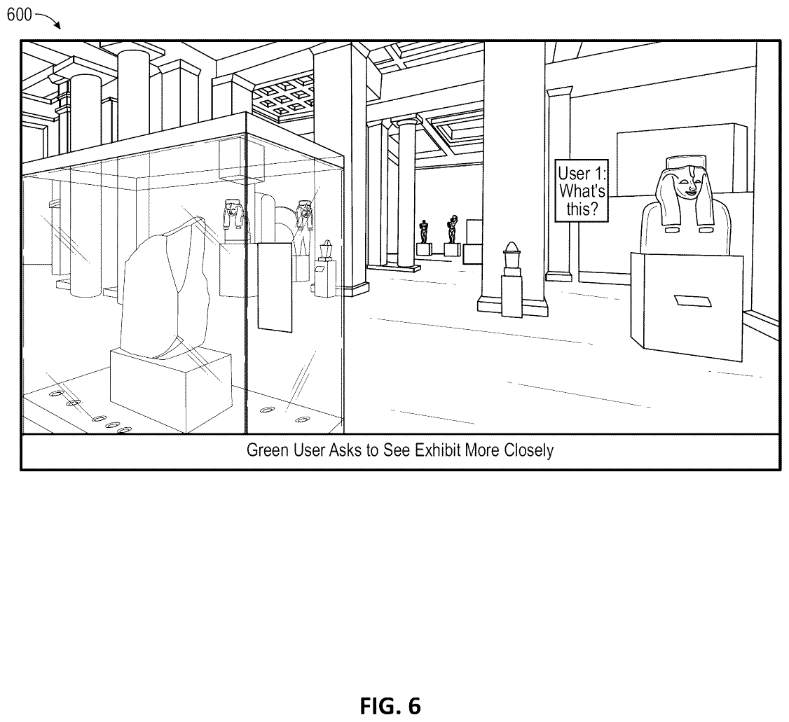

The XR application may transmit a signal to cause an extended reality (XR) device at the 3D location to generate for display an augmentation for the 3D object in the 3D location. In FIG. 1, at 106, the XR application transmits a message to augment the sphinx (i.e., by highlighting the sphinx with a colored overlay having opacity) in the 3D XR environment such that the XR concierge can unambiguously determine that this is the object of interest about which the user device wishes to know further information. The XR concierge further provides information on the sphinx reciting “The largest and most famous sphinx is the Great Sphinx of Giza in Egypt.” At 108, the graphical representation of the XR concierge in the 3D XR environment is mapped to the 2D graphical representation on the tablet, which states the same. In some embodiments, the augmentation for the 3D object in the 3D location includes, but is not limited to, an indicator that appears proximate to the 3D object, highlighting that appears overlaid on the 3D object, an overlay proximate to the 3D object, and a messaging interface proximate to the 3D object. FIG. 6 shows illustrative diagram 600 of a 2D graphical representation of a user interacting with an XR host, in accordance with some embodiments of this disclosure. The XR application augments the sphinx by highlighting it in a colored overlay having opacity.

In some embodiments, the graphical representation comprises a 3D graphical representation of the 3D location on the client device. For example, the client device may be a VR headset viewing an environment in 3D. The XR application may then identify the correspondence between the graphical object in the portion of the 3D graphical representation (e.g., the VR headset as the client device) and the 3D object in the 3D location (e.g., the XR headset used by the XR Concierge). In some embodiments, the 3D graphical representation is a digital twin of the real-world environment (i.e., the 3D location). In some embodiments, the XR application may store one or more actions that take place in the 3D graphical representation from one or more client devices. For example, ten or more users take selfies in VR at roughly the same specific spatial location. The XR application may designate that spatial location in actual reality a point of interest. The XR application may transmit information about a point of interest with respect to the present environment, to an AR device overlaying AR in a real environment (e.g., using AR headset in a park). In some embodiments, the XR application continuously updates the mapping during the XR session. In some embodiments, the XR application updates the mapping upon any movement within the 3D graphical representation. In some embodiments, the XR application may implement a predefined spatial boundary for rendering (e.g., calculated visible line of sight, pre-determined distance of one-mile radius, limit of room size within building, etc.).

In some embodiments, the XR application may be embedded within the XR device itself. The XR application may create, on the XR device, the graphical representation of the 3D location. For example, the XR device may be an AR/VR headset that is being worn within a museum by the XR concierge. The AR/VR headset provides the requisite hardware to optically capture the museum environment and create a 3D graphical representation of the museum. The mapping device may store the graphical representation of the 3D location in memory. For example, the AR/VR headset may store the 3D graphical representation within embedded memory. The XR application may receive an input, via the client device, requesting the graphical representation of the 3D location. For example, a tablet accessing a museum tour may request the library view from the XR concierge. The XR application may then retrieve the graphical representation of the 3D location from the memory and provide the graphical representation of the 3D location to the client device. For example, the AR/VR device may provide the mapping for the museum to the tablet client device. In some embodiments, the XR application will provide the corresponding mapping of the 3D location to the 2D client device.

In some embodiments, the 2D client device may be fully aware of full 3D objects of the 3D graphical representation. Full object point clouds or 3D mesh and metadata may be sent by the XR application to the video client from the AR headset, along with a mapping function to translate between said cloud spatial coordinates and the current 2D video viewport coordinates. Inputs (where the AR client is looking, for example) for this mapping function can be updated every time the AR headset moves or rotates. In another embodiment, the 2D client device may be fully aware of translated 2D objects. In this implementation, a list of objects and associated metadata along with the current 2D coordinates of their facing planes is sent to the video client. This list must be updated every time the AR headset moves or rotates. In yet another embodiment, the 2D client device may be aware only of clicks input over a 2D video. In this approach, only the video is sent to the video client. The video client merely reports back click data on the viewport to the XR application, and the AR headset handles figuring out what real-world object was interacted with. No object updates for the 2D client are required in this implementation, but the XR application needs to correlate the object selected from the 2D screen via click to the objects data to identify which objects were clicked or otherwise identified by the interface of the 2D client device.

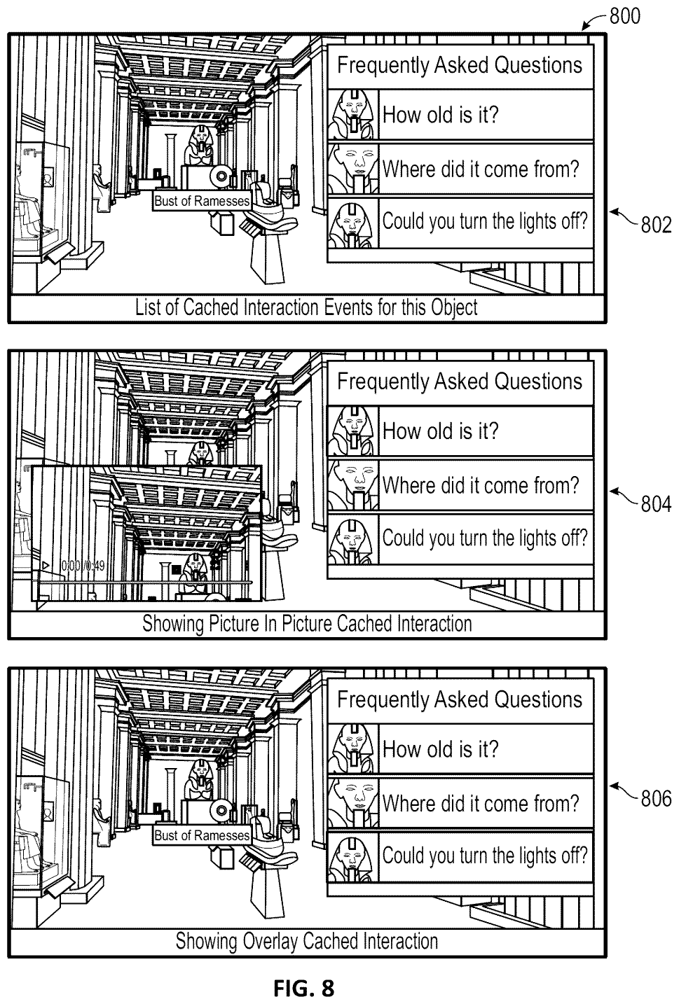

In some embodiments, the XR application records the augmentation for the 3D object in the 3D location that is generated for display in memory. For example, in some scenarios the client device may wish to interact with a live XR concierge; however, the XR concierge is not live at the moment of desired interaction. In this example, the XR application may store the augmentation and provide a recording to the client device. The XR application may receive an input, via the client device, requesting the augmentation for the 3D object in the 3D location. The XR application may then retrieve the augmentation for the 3D object in the 3D location from the memory and provide the augmentation for the 3D object in the 3D location to the client device. For example, the tablet client device may request information about the sphinx when the XR concierge is not live as the XR tour was completed weeks ago upon a museum exhibition commencing. The XR application determines that the request for further information about the sphinx is stored in memory. The XR application retrieves this recording of further information about the sphinx and provides it to the client device as requested. In some embodiments, these recorded augmentations are stored in memory (e.g., cache). The XR application may generate for display user interfaces having queues of previous recorded augmentations based on/sorted in relation to a received query from a client device. For example, the XR application may generate for display the recorded augmentations in a user interface that provides for a list of stored augmentations. The list of stored augmentations may have corresponding thumbnails and/or icons relating to the specific augmentation. In some embodiments, the XR application can assign metadata to the stored recorded augmentations. In this way, based on received inputs from client devices, the XR application may be able to easily sort for relevant augmentations to provide as relevant recorded augmentations for the requesting client devices. In one example, if the client device is 3D compatible (e.g., an AR headset) and the client device is within the line of sight of an object that has a previously recorded augmentation, the XR application may highlight the object for which the previously recorded augmentation took place (e.g., the sphinx object). In this way, the user using AR glasses knows, while walking through the real 3D environment, that there is content relating to the sphinx as it is highlighted. FIG. 8 shows further additional illustrative diagrams 800 of a 2D graphical representation of a user interacting with an XR host, in accordance with some embodiments of this disclosure. At 802, the XR application may generate for display the cached historical content in 2D video mode, having a “picture in picture” view showing the clip labeled as answering the associated question. At 804, the XR application may generate for display the cached content in 3D video mode, through a 3D overlay or switching to other 3D video content entirely. In this example of the cached video, a live tour user asked the XR host to turn off lights in the physical space.

In some embodiments, the XR application receives a set of coordinates, via the client device, on a portion of the graphical representation. In some embodiments, the set of coordinates may be received by the XR application by a mouse click, a selection, a touch on a touchscreen, or a point of interest based on eye gaze. For example, the XR application uses embedded hardware (e.g, front-facing camera on tablet) to determine eye gaze, to identify which portion of the graphical representation the user is viewing. The XR application may, based on the set of coordinates, identify a correspondence between a graphical object at the set of coordinates and a 3D object in the 3D location. For example, the XR application may determine that the user is looking at the sphinx more than any other object in a specified time interval. The XR application may transmit a second signal to cause the XR device at the 3D location to generate for display the augmentation for the 3D object in the 3D location. For example, without an active input conducted on the part of the client device; but rather a passive eye gaze, the XR application tells the XR device to augment the sphinx for the concierge to note that the client device views this as interesting and perhaps wants more information regarding the sphinx.

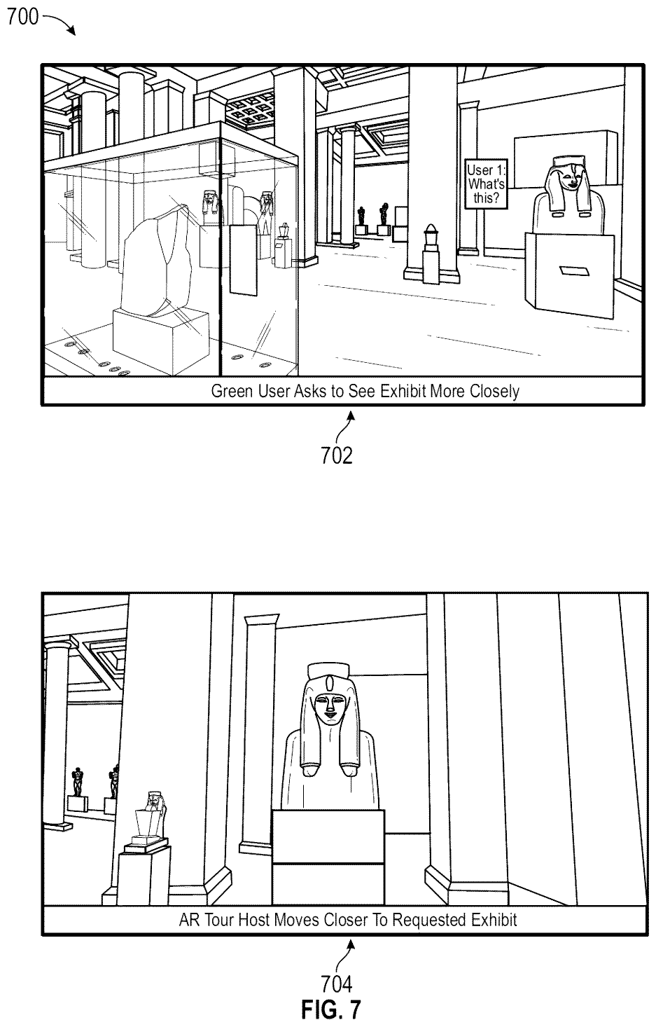

In some embodiments, the XR application receives a plurality of sets of coordinates from a plurality of client devices. In this scenario, the XR application may receive a crowdsourced set of data relating to eye gaze from a plurality of devices. This information may be processed to function as a “heat map” that indicates the most popular portions, a coordinate of interest, of eye gaze, by the plurality of devices. The XR application may determine the coordinate of interest based on applying a mathematical model to the plurality of sets of coordinates. The mathematical model may be any one of a machine learning model, lineal regression on coordinates, mean/mode of coordinates, and other similar mathematical models. The XR application may, based on the coordinate of interest, identify a correspondence between a graphical object at the coordinate of interest and a 3D object in the 3D location. The XR application may transmit a third signal to cause the XR device at the 3D location to generate for display the augmentation for the 3D object in the 3D location. In some embodiments, after the signal is transmitted, the object is highlighted for the XR device to perform the augmentation. In some embodiments, after the signal is transmitted, the object is described to the XR device (e.g., via audio or video, or text) for the XR device to perform the augmentation. FIG. 7 shows additional illustrative diagrams of a 2D graphical representation 700 of a user interacting with an XR host, in accordance with some embodiments of this disclosure. At 702, the XR host is moving to the indicated location (e.g., the sphinx) and the XR application provides further information about the sphinx captured from the XR host to be relayed over audio to the client device. At 704, a non-live embodiment is shown, where the XR application provides cached requests/questions received during one or more live sessions and stores them to be reviewed later. In some embodiments, these requests are accessible by client devices on demand. This may prevent the live XR host from answering the same questions over and over, as well as providing information for those who could not attend the live event. The cache in the form of memory storage is accessed as objects are interacted with live, via the XR application translating from 2D graphical representations to a different graphical representation. In this way, one or more recorded/cached events may be used as an “on-demand” service to provide 2D, AR, VR tours to one or more client devices that may vary in graphical representation capabilities. It may serve as location-based XR/3D/2D frequently asked questions (FAQ). In some embodiments, the XR application may provide FAQ to the client device upon the client device being within proximity of the specific location for which the particular FAQ is relevant. For example, a user with a VR headset is touring a museum in VR and they walk in front of the sphinx. The XR application sends the user an option to open an audio FAQ about the sphinx such that the user can still visually admire the sphinx while hearing audio-based FAQ about the sphinx.

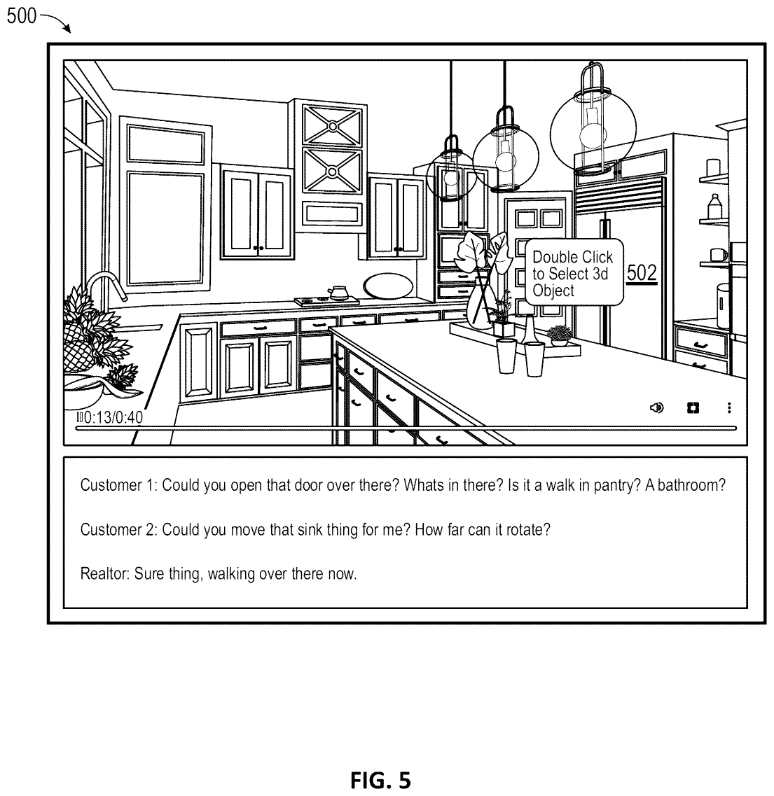

FIG. 5 shows an illustrative diagram 500 of a 2D graphical representation of a home tour, in accordance with some embodiments of this disclosure. This example provides for a home tour use case from the point of view of a video call client participant (2D graphical representation), viewing a normal text chat. The XR concierge is wearing an AR headset and is live in the home. The 2D video feed at the client device is being sourced from the AR headset-wearing XR host, and thus moving with their point of view. In this instance, the XR application sends converted objects from AR 3D to the 2D video client. The 2D client device handles converting between screen coordinates and the 3D coordinates of the objects in the remote mapped physical space and thus can show information about the objects before notifying the AR headset and host.

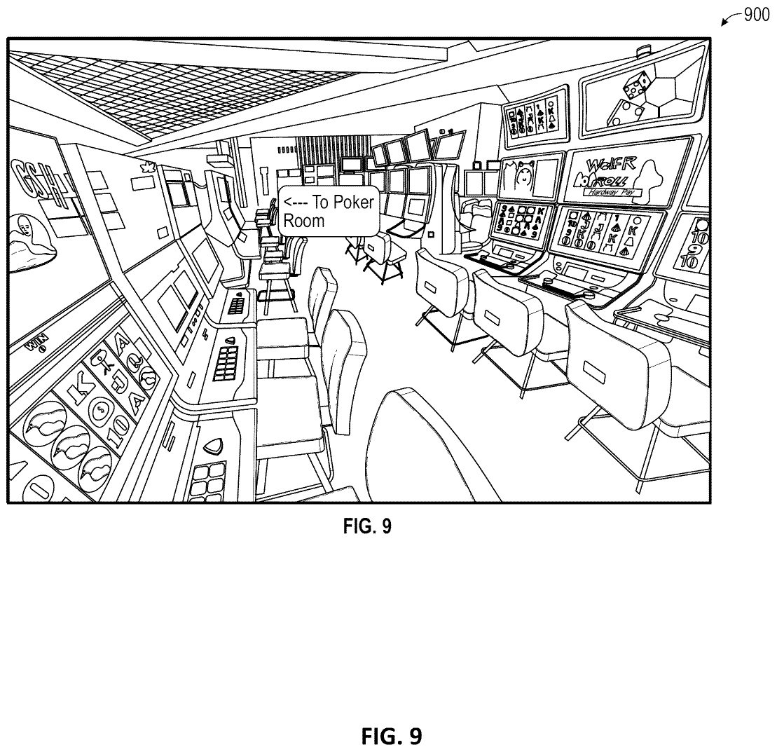

FIG. 9 shows an illustrative diagram 900 of a 2D graphical representation of a casino, in accordance with some embodiments of this disclosure. In this example, an XR host is walking through a common tourist destination, a casino. In this example, the XR application may cache location-based, tour-related content. Common information in live tours can be cached, translated to visual formats (such as arrows or hovering overlays) and displayed in novel formats to live or on-demand clients. In some embodiments, the XR host may physically walk to locations to answer questions. In other embodiments, a client device may wish to access a video-on-demand tour with a more abbreviated tour such as an arrow or virtual sign. The XR application may implement these virtual UI elements, and these elements can be placed in 3D space (such as through SLAM maps) by the AR user, and then accessed as 2D or 3D content by appropriate clients.

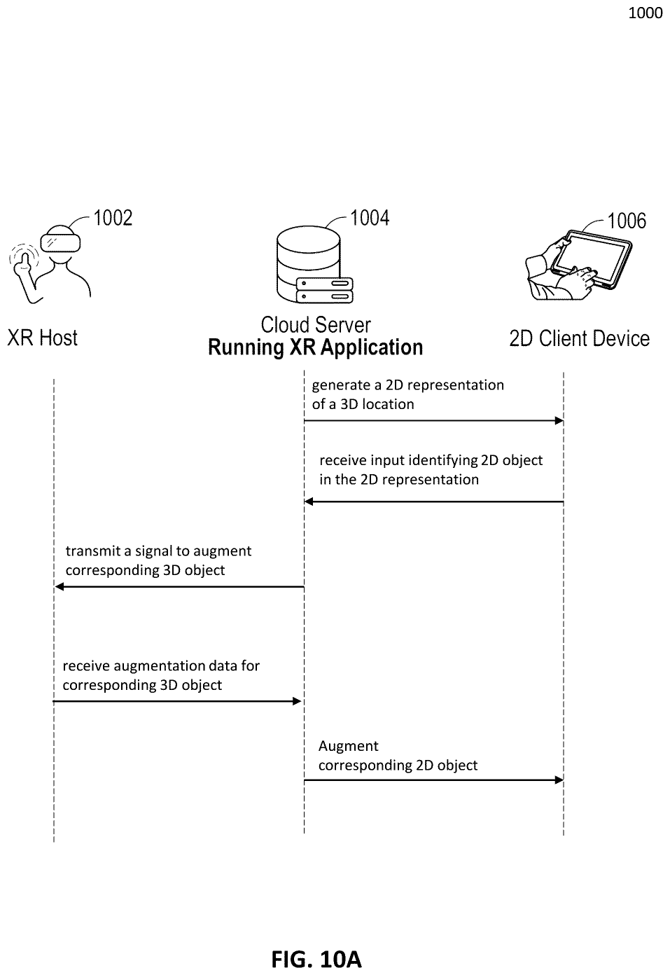

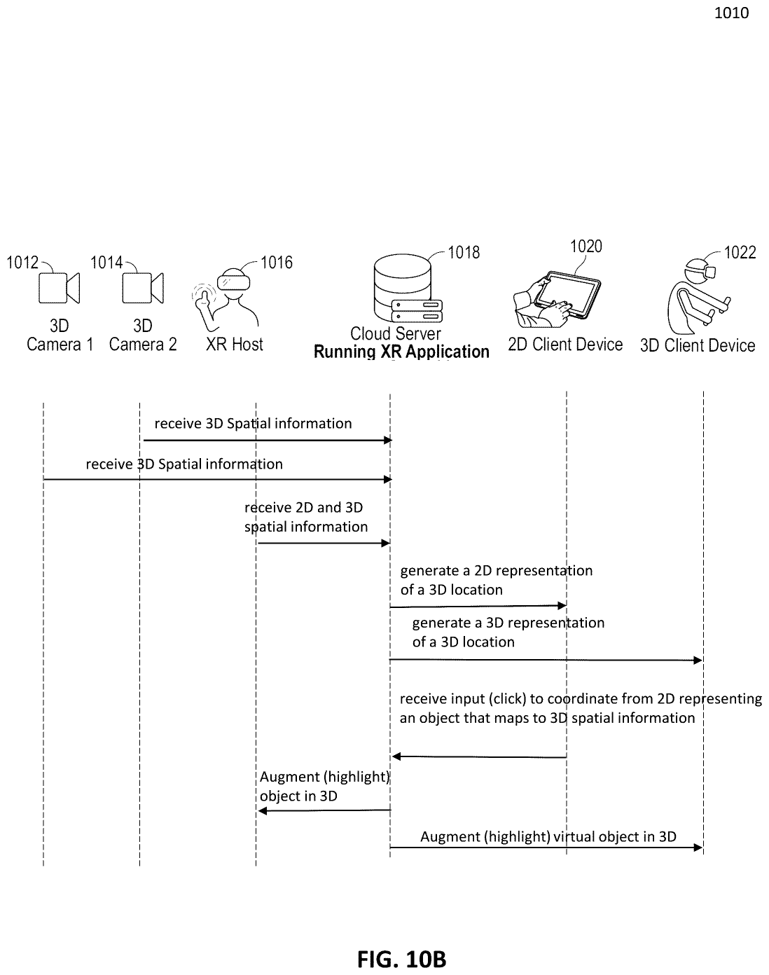

FIG. 10A shows an illustrative flow diagram 1000 of an XR host 1002, cloud server 1004, and 2D client device 1006, in accordance with some embodiments of this disclosure. In this example, the XR application (e.g., cloud-based server 1004) generates a 2D representation of a 3D location. As an example, the generated 2D representation can be seen in FIG. 1 at 102, where the 3D museum environment is converted into a video feed rendered on a tablet device. The XR application then receives input identifying a 2D object in the 2D representation from the 2D client device. This may be seen at 102-104 as well where a sphinx object is identified. The XR application then transmits a signal to augment the corresponding 3D object. The XR application then receives augmentation data for the corresponding 3D object from the XR host hardware (e.g., AR headset). The XR application then, based on the mapping, augments the corresponding 2D object for the 2D client device. This may be seen at 106 where the sphinx is augmented by highlighting the sphinx in color, and further information is provided about the Great Sphinx of Giza, which is sent to the 2D graphical representation via audio and video text seen at 108.

FIG. 10B shows an illustrative flow diagram 1010 of an XR host 1016, cloud server 1018, 2D client device 1020, 3D client device 1022, and multiple 3D cameras 1012 and 1014, in accordance with some embodiments of this disclosure. In this example, the XR application (e.g., cloud-based server 1018) receives 3D spatial information from 3D cameras 1 and 2. This 3D spatial information is used to characterize one or more objects within the 3D space. The XR application may also receive 2D and 3D spatial information from the XR host, who may be wearing an AR headset or a VR headset. The XR application may generate a 2D representation of a 2D location for the 2D client device and a 3D representation for the 3D client device. The XR application then receives input (e.g., a click) identifying a 2D object in the 2D representation from the 2D client device (e.g., tablet). The click has 2D coordinates that map to a corresponding 3D object in 3D spatial coordinates. The XR application performs this mapping between 2D and 3D. The XR application then transmits a signal to augment the corresponding 3D object for the XR host (e.g., highlights the object). The XR application also transmits augmentation data to the 3D client device to highlight the object in virtual reality in 3D as well.

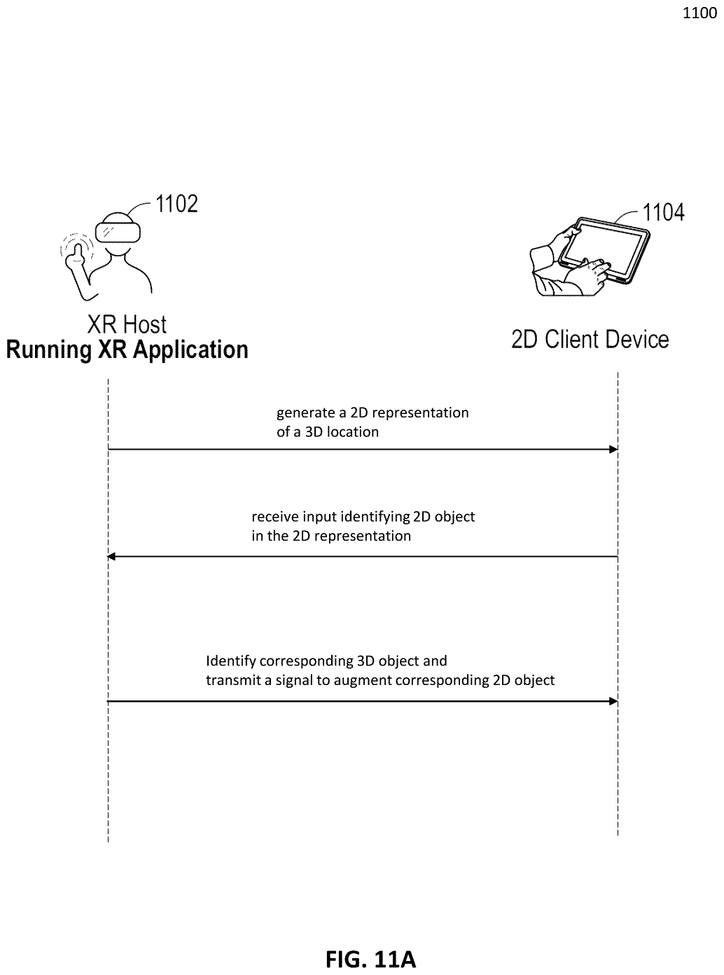

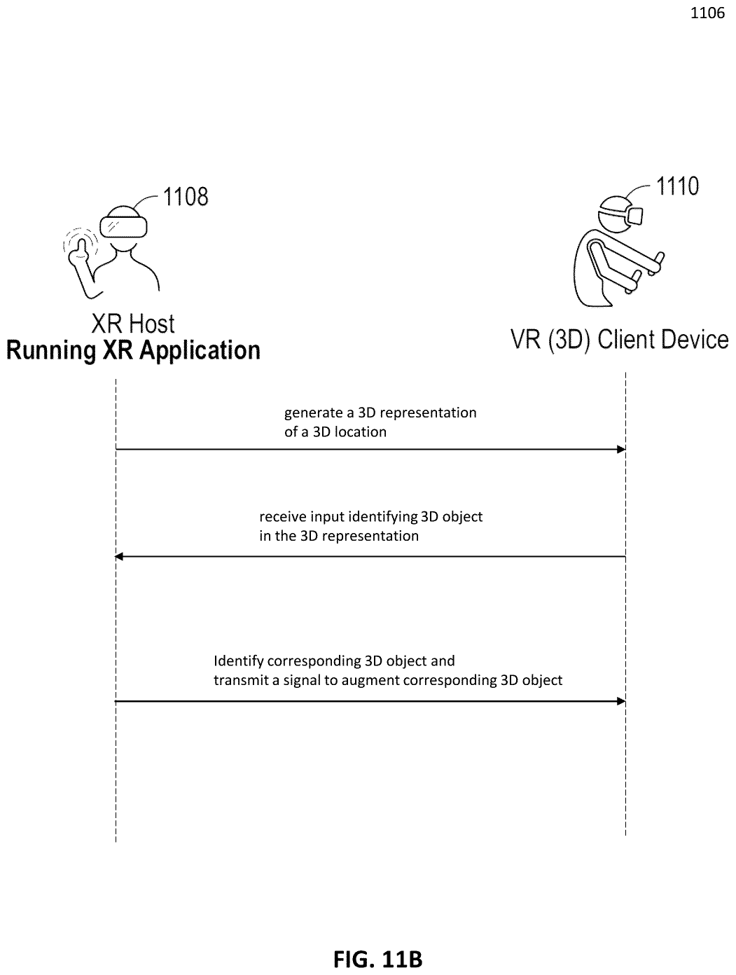

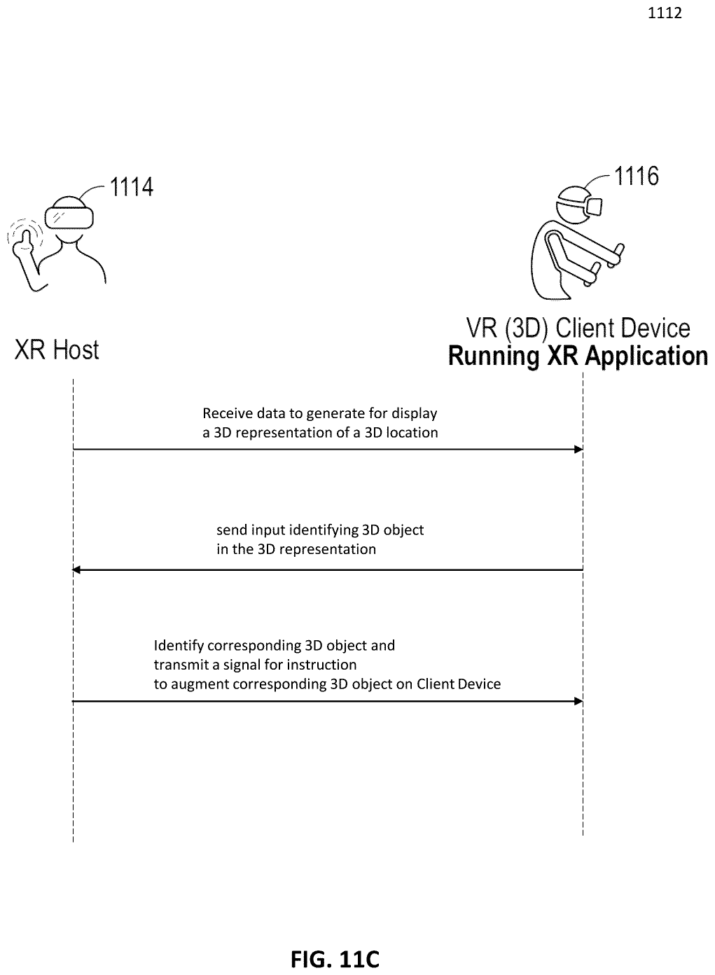

FIG. 11A shows an illustrative flow diagram 1100 of an XR host 1102 and 2D client device 1104, in accordance with some embodiments of this disclosure. In this example, the XR host and 2D client device are configured to operate in a peer-to-peer configuration. In this example, the XR host comprises the XR application processing. The XR application, within the XR headset worn by the XR host, receives input identifying a 2D object in the 2D graphical representation at the 2D client device (e.g., a tablet device). The XR application then, based on a mapping, identifies a corresponding 3D object in the 3D graphical representation and transmits a signal to augment the corresponding 2D object.

FIG. 11B shows an illustrative flow diagram 1106 of an XR host 1108 and 3D client device 1110, in accordance with some embodiments of this disclosure. In this example, the XR host and 3D client device are configured to operate in a peer-to-peer configuration. In this example, the XR host comprises the XR application processing. The XR application, within the XR headset worn by the XR host, receives input identifying a 3D object in the 3D graphical representation at the 3D client device (e.g., a VR headset). The XR application then, based on a mapping, identifies a corresponding 3D object in the 3D graphical representation and transmits a signal to augment corresponding 3D object. For example, this could be an AR host sending information to a VR client device.

FIG. 11C shows an illustrative flow diagram 1112 of another XR host 1114 and 3D client device 1116, in accordance with some embodiments of this disclosure. In this example, the XR host and 3D client device are configured to operate in a peer-to-peer configuration. In this example, the 3D client device 1116 comprises the XR application processing. The XR application, within the VR headset worn by the user on the client device, receives data to generate for display a 3D representation of a 3D location. The XR application may send an input identifying a 3D object in the 3D representation to the XR host (e.g., the sphinx). The XR application then receives the identified corresponding 3D object and transmits a signal to the VR client device to augment corresponding 3D object.

In some embodiments, the client device (e.g., an AR headset) user is walking through a museum. There is no live XR concierge at this location at the same time. As the user walks through the museum, depending on location and eye-gaze point of view, the XR application may highlight one or more objects of interest for which there is previously recorded content by a previous XR host. In this way, the AR user can engage cached content for objects of interest as they walk through the museum.

In some embodiments, the example is similar to the one listed above; however, there is a live XR host as well within the museum. The client device (e.g., an AR headset) user is walking through the museum. As the user walks through the museum, the user wishes to learn more about an object for which there is no cached content. The client device sends a communication message to the XR host (e.g., screenshot of object of interest along with audio voice note that requests further information on the object). The XR application may send this information to the XR host, which receives this request. The XR host then walks to the object and provides further information. The XR application alerts the user that the request for further information has been obliged. The XR application records the further information provided by the XR host. The XR application then caches this information for future possible requests about this specific object.

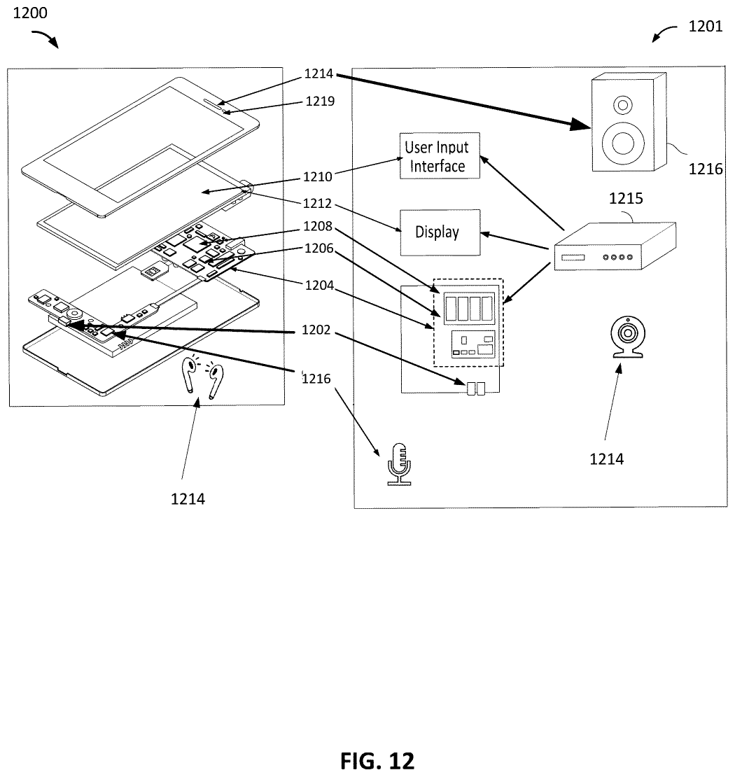

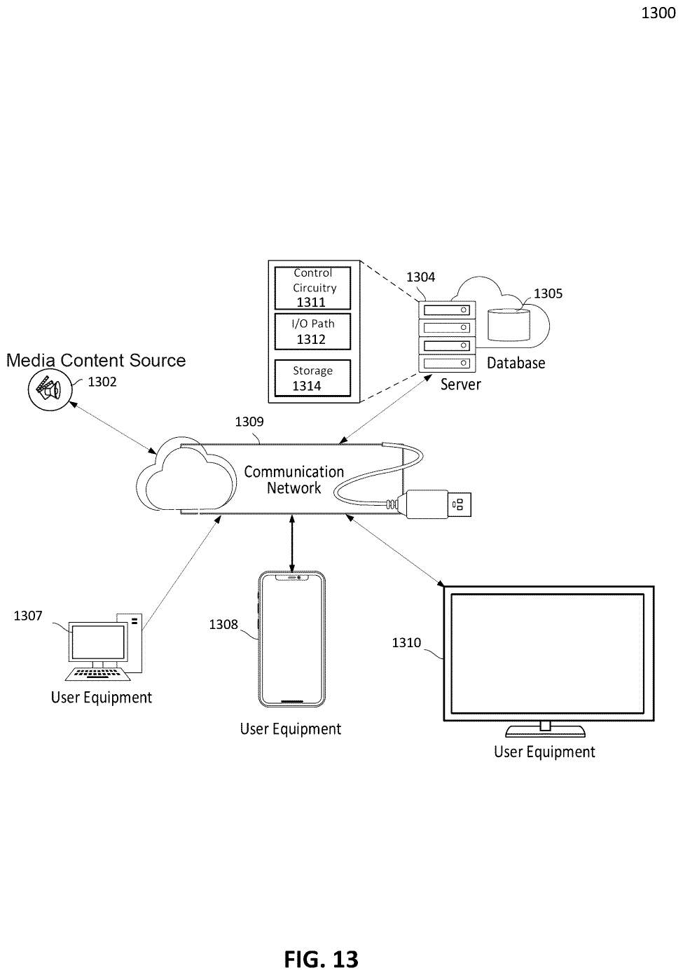

FIGS. 12-13 describe illustrative devices, systems, servers, and related hardware for an asymmetrical XR application for efficient navigation configured to generate a graphical representation of a real 3D environment, receive a client device input selecting an object, mapping the object to a 3D object in mixed reality, and augmenting the 3D object in mixed reality, in accordance with some embodiments of this disclosure. FIG. 12 shows generalized embodiments of illustrative user devices 1200 and 1201, which may correspond to, e.g., client user devices and/or XR devices shown in FIGS. 1, 2, 10, and 11 or any combination thereof. For example, user equipment device 1200 may be a smartphone device, a tablet, smart glasses, a virtual reality or augmented reality device, or any other suitable device capable of consuming media assets and capable of transmitting and receiving data over a communication network. In another example, user equipment device 1201 may be a user television equipment system or device. User television equipment device 1201 may include set-top box 1215. Set-top box 1215 may be communicatively connected to microphone 1216, audio output equipment (e.g., speaker or headphones 1214), and display 1212. In some embodiments, microphone 1216 may receive audio corresponding to a voice of a user, e.g., a voice command. In some embodiments, display 1212 may be a television display or a computer display. In some embodiments, set-top box 1215 may be communicatively connected to user input interface 1210. In some embodiments, user input interface 1210 may be a remote control device. Set-top box 1215 may include one or more circuit boards. In some embodiments, the circuit boards may include control circuitry, processing circuitry, and storage (e.g., RAM, ROM, hard disk, removable disk, etc.). In some embodiments, the circuit boards may include an input/output path. More specific implementations of user equipment devices are discussed below in connection with FIG. 12. In some embodiments, device 1200 may comprise any suitable number of sensors, as well as a GPS module (e.g., in communication with one or more servers and/or cell towers and/or satellites) to ascertain a location of device 1200.

Each one of user equipment device 1200 and user equipment device 1201 may receive content and data via input/output (I/O) path 1202. I/O path 1202 may provide content (e.g., broadcast programming, on-demand programming, Internet content, content available over a local area network (LAN) or wide area network (WAN), and/or other content) and data to control circuitry 1204, which may comprise processing circuitry 1206 and storage 1208. Control circuitry 1204 may be used to send and receive commands, requests, and other suitable data using I/O path 1202, which may comprise I/O circuitry. I/O path 1202 may connect control circuitry 1204 (and specifically processing circuitry 1206) to one or more communications paths (described below). I/O functions may be provided by one or more of these communications paths, but are shown as a single path in FIG. 12 to avoid overcomplicating the drawing. While set-top box 1215 is shown in FIG. 12 for illustration, any suitable computing device having processing circuitry, control circuitry, and storage may be used in accordance with the present disclosure. For example, set-top box 1215 may be replaced by, or complemented by, a personal computer (e.g., a notebook, a laptop, a desktop), a smartphone (e.g., device 1200), a tablet, a network-based server hosting a user-accessible client device, a non-user-owned device, any other suitable device, or any combination thereof.

Control circuitry 1204 may be based on any suitable control circuitry such as processing circuitry 1206. As referred to herein, control circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 1204 executes instructions for the XR application stored in memory (e.g., storage 1208). Specifically, control circuitry 1204 may be instructed by the XR application to perform the functions discussed above and below. In some implementations, processing or actions performed by control circuitry 1204 may be based on instructions received from the XR application.

In client/server-based embodiments, control circuitry 1204 may include communications circuitry suitable for communicating with a server or other networks or servers. The XR application may be a stand-alone application implemented on a device or a server. The XR application may be implemented as software or a set of executable instructions. The instructions for performing any of the embodiments discussed herein of the XR application may be encoded on non-transitory computer-readable media (e.g., a hard drive, random-access memory on a DRAM integrated circuit, read-only memory on a BLU-RAY disk, etc.). For example, in FIG. 12, the instructions may be stored in storage 1208, and executed by control circuitry 1204 of a device 1200.

In some embodiments, the XR application may be a client/server application where only the client application resides on device 1200, and a server application resides on an external server (e.g., server 1304 and/or server 1316). For example, the XR application may be implemented partially as a client application on control circuitry 1204 of device 1200 and partially on server 1304 as a server application running on control circuitry 1311. Server 1304 may be a part of a local area network with one or more of devices 1200 or may be part of a cloud computing environment accessed via the internet. In a cloud computing environment, various types of computing services for performing searches on the internet or informational databases, providing storage (e.g., for a database) or parsing data are provided by a collection of network-accessible computing and storage resources (e.g., server 1304), referred to as “the cloud.” Device 1200 may be a cloud client that relies on the cloud computing capabilities from server 1304 to determine whether processing should be offloaded and facilitate such offloading. When executed by control circuitry 1204 or 1311, the XR application may instruct control circuitry 1204 or 1311 circuitry to perform processing tasks for the client device and facilitate a media consumption session integrated with social network services. The client application may instruct control circuitry 1204 to determine whether processing should be offloaded.

Control circuitry 1204 may include communications circuitry suitable for communicating with a server, social network service, a table or database server, or other networks or servers The instructions for carrying out the above-mentioned functionality may be stored on a server (which is described in more detail in connection with FIG. 12). Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communication networks or paths (which is described in more detail in connection with FIG. 12). In addition, communications circuitry may include circuitry that enables peer-to-peer communication of user equipment devices, or communication of user equipment devices in locations remote from each other (described in more detail below).

Memory may be an electronic storage device provided as storage 1208 that is part of control circuitry 1204. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 1208 may be used to store various types of content described herein as well as XR application data described above. Nonvolatile memory may also be used (e.g., to launch a boot-up routine and other instructions). Cloud-based storage may be used to supplement storage 1208 or instead of storage 1208.

Control circuitry 1204 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 1204 may also include scaler circuitry for upconverting and downconverting content into the preferred output format of user equipment 1200. Control circuitry 1204 may also include digital-to-analog converter circuitry and analog-to-digital converter circuitry for converting between digital and analog signals. The tuning and encoding circuitry may be used by user equipment device 1200, 1201 to receive and to display, to play, or to record content. The tuning and encoding circuitry may also be used to receive media consumption data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 1208 is provided as a separate device from user equipment device 1200, the tuning and encoding circuitry (including multiple tuners) may be associated with storage 1208.

Control circuitry 1204 may receive instruction from a user by way of user input interface 1210. User input interface 1210 may be any suitable user interface, such as a remote control, mouse, trackball, keypad, keyboard, touch screen, touchpad, stylus input, joystick, voice recognition interface, or other user input interfaces. Display 1212 may be provided as a stand-alone device or integrated with other elements of each one of user equipment device 1200 and user equipment device 1201. For example, display 1212 may be a touchscreen or touch-sensitive display. In such circumstances, user input interface 1210 may be integrated with or combined with display 1212. In some embodiments, user input interface 1210 includes a remote-control device having one or more microphones, buttons, keypads, any other components configured to receive user input or combinations thereof. For example, user input interface 1210 may include a handheld remote-control device having an alphanumeric keypad and option buttons. In a further example, user input interface 1210 may include a handheld remote-control device having a microphone and control circuitry configured to receive and identify voice commands and transmit information to set-top box 1215.

Audio output equipment 1214 may be integrated with or combined with display 1212. Display 1212 may be one or more of a monitor, a television, a liquid crystal display (LCD) for a mobile device, amorphous silicon display, low-temperature polysilicon display, electronic ink display, electrophoretic display, active matrix display, electro-wetting display, electro-fluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. A video card or graphics card may generate the output to the display 1212. Audio output equipment 1214 may be provided as integrated with other elements of each one of device 1200 and equipment 1201 or may be stand-alone units. An audio component of videos and other content displayed on display 1212 may be played through speakers (or headphones) of audio output equipment 1214. In some embodiments, audio may be distributed to a receiver (not shown), which processes and outputs the audio via speakers of audio output equipment 1214. In some embodiments, for example, control circuitry 1204 is configured to provide audio cues to a user, or other audio feedback to a user, using speakers of audio output equipment 1214. There may be a separate microphone 1216 or audio output equipment 1214 may include a microphone configured to receive audio input such as voice commands or speech. For example, a user may speak letters or words that are received by the microphone and converted to text by control circuitry 1204. In a further example, a user may voice commands that are received by a microphone and recognized by control circuitry 1204. Camera 1218 may be any suitable video camera integrated with the equipment or externally connected. Camera 1218 may be a digital camera comprising a charge-coupled device (CCD) and/or a complementary metal-oxide semiconductor (CMOS) image sensor. Camera 1218 may be an analog camera that converts to digital images via a video card.

The XR application may be implemented using any suitable architecture. For example, it may be a stand-alone application wholly-implemented on each one of user equipment device 1200 and user equipment device 1201. In such an approach, instructions of the application may be stored locally (e.g., in storage 1208), and data for use by the application is downloaded on a periodic basis (e.g., from an out-of-band feed, from an Internet resource, or using another suitable approach). Control circuitry 1204 may retrieve instructions of the application from storage 1208 and process the instructions to provide media consumption and social network interaction functionality and generate any of the displays discussed herein. Based on the processed instructions, control circuitry 1204 may determine what action to perform when input is received from user input interface 1210. For example, movement of a cursor on a display up/down may be indicated by the processed instructions when user input interface 1210 indicates that an up/down button was selected. An application and/or any instructions for performing any of the embodiments discussed herein may be encoded on computer-readable media. Computer-readable media includes any media capable of storing data. The computer-readable media may be non-transitory including, but not limited to, volatile and non-volatile computer memory or storage devices such as a hard disk, floppy disk, USB drive, DVD, CD, media card, register memory, processor cache, Random Access Memory (RAM), etc.

Control circuitry 1204 may allow a user to provide user profile information or may automatically compile user profile information. For example, control circuitry 1204 may access and monitor network data, video data, audio data, processing data, participation data from a XR application and social network profile. Control circuitry 1204 may obtain all or part of other user profiles that are related to a particular user (e.g., via social media networks), and/or obtain information about the user from other sources that control circuitry 1204 may access. As a result, a user can be provided with a unified experience across the user's different devices.

In some embodiments, the XR application is a client/server-based application. Data for use by a thick or thin client implemented on each one of user equipment device 1200 and user equipment device 1201 may be retrieved on-demand by issuing requests to a server remote to each one of user equipment device 1200 and user equipment device 1201. For example, the remote server may store the instructions for the application in a storage device. The remote server may process the stored instructions using circuitry (e.g., control circuitry 1204) and generate the displays discussed above and below. The client device may receive the displays generated by the remote server and may display the content of the displays locally on device 1200. This way, the processing of the instructions is performed remotely by the server while the resulting displays (e.g., that may include text, a keyboard, or other visuals) are provided locally on device 1200. Device 1200 may receive inputs from the user via input interface 1210 and transmit those inputs to the remote server for processing and generating the corresponding displays. For example, device 1200 may transmit a communication to the remote server indicating that an up/down button was selected via input interface 1210. The remote server may process instructions in accordance with that input and generate a display of the application corresponding to the input (e.g., a display that moves a cursor up/down). The generated display may then be transmitted to device 1200 for presentation to the user.

In some embodiments, the XR application may be downloaded and interpreted or otherwise run by an interpreter or virtual machine (run by control circuitry 1204). In some embodiments, the XR application may be encoded in the ETV Binary Interchange Format (EBIF), received by control circuitry 1204 as part of a suitable feed, and interpreted by a user agent running on control circuitry 1204. For example, the XR application may be an EBIF application. In some embodiments, the XR application may be defined by a series of JAVA-based files that are received and run by a local virtual machine or other suitable middleware executed by control circuitry 1204. In some of such embodiments (e.g., those employing MPEG-2 or other digital media encoding schemes), the XR application may be, for example, encoded and transmitted in an MPEG-2 object carousel with the MPEG audio and video packets of a program.

FIG. 13 is a diagram of an illustrative system 1300, in accordance with some embodiments of this disclosure. User equipment devices 1307, 1308, 1310 (e.g., user device and/or XR device in FIGS. 1, 2, 10, and 11; devices or any other suitable devices, or any combination thereof) may be coupled to communication network 1306. Communication network 1306 may be one or more networks including the Internet, a mobile phone network, mobile voice or data network (e.g., a 5G, 4G, or LTE network, or any other suitable network or any combination thereof), cable network, public switched telephone network, or other types of communication network or combinations of communication networks. Paths (e.g., depicted as arrows connecting the respective devices to the communication network 1306) may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. Communications with the client devices may be provided by one or more of these communications paths but are shown as a single path in FIG. 13 to avoid overcomplicating the drawing.

Although communications paths are not drawn between user equipment devices, these devices may communicate directly with each other via communications paths as well as other short-range, point-to-point communications paths, such as USB cables, IEEE 1394 cables, wireless paths (e.g., Bluetooth, infrared, IEEE 702-11x, etc.), or other short-range communication via wired or wireless paths. The user equipment devices may also communicate with each other directly through an indirect path via communication network 1306.

System 1300 may comprise media content source 1302, one or more servers 1304, and one or more social network services. In some embodiments, the XR application may be executed at one or more of control circuitry 1311 of server 1304 (and/or control circuitry of user equipment devices 1307, 1308, 1310.

In some embodiments, server 1304 may include control circuitry 1311 and storage 1314 (e.g., RAM, ROM, Hard Disk, Removable Disk, etc.). Instructions for the XR application may be stored in storage 1314. In some embodiments, the XR application, via control circuitry, may execute functions outlined in FIGS. 1-11. Storage 1314 may store one or more databases. Server 1304 may also include an input/output path 1312. I/O path 1312 may provide media consumption data, social networking data, device information, or other data, over a local area network (LAN) or wide area network (WAN), and/or other content and data to control circuitry 1311, which may include processing circuitry, and storage 1314. Control circuitry 1311 may be used to send and receive commands, requests, and other suitable data using I/O path 1312, which may comprise I/O circuitry. I/O path 1312 may connect control circuitry 1311 (and specifically control circuitry) to one or more communications paths. I/O path 1312 may comprise I/O circuitry.

Control circuitry 1311 may be based on any suitable control circuitry such as one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry 1311 may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 1311 executes instructions for an emulation system application stored in memory (e.g., the storage 1314). Memory may be an electronic storage device provided as storage 1314 that is part of control circuitry 1311.

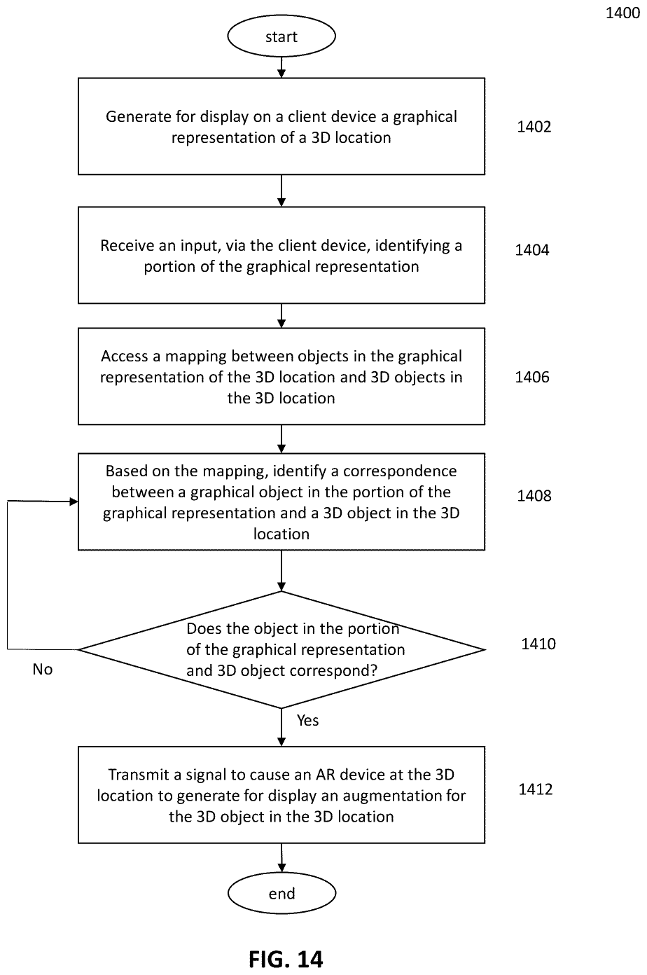

FIG. 14 is a flowchart of a detailed illustrative process for transmitting a signal to cause an AR device at the 3D location to generate for display an augmentation for the 3D object in the 3D location, in accordance with some embodiments of this disclosure. In various embodiments, the individual steps of process 1400 may be implemented by one or more components of the devices and systems of FIGS. 1-13. Although the present disclosure may describe certain steps of process 1400 (and of other processes described herein) as being implemented by certain components of the devices and systems of FIGS. 1-13, this is for purposes of illustration only, and it should be understood that other components of the devices and systems of FIGS. 1-13 may implement those steps instead.

At 1402, the XR application, via the I/O path 1312, generates for display on a client device (e.g., smart phone, tablet, AR headset, VR headset, laptop, television, personal computer, etc.) a graphical representation of a 3D location. At 1404, the XR application, via the I/O path 1312, receives an input (e.g., via touchscreen, keyboard, voice, gesture, instruction, code, eye gaze, etc.), via the client device (e.g., user equipment 1307, 1308, 1310), identifying a portion of the graphical representation. At 1406, the XR application, via the I/O path 1312 and/or control circuitry 1311, accesses (e.g., via networking, Bluetooth, internal bus, wireless communication, wired communication, or any suitable digital communication medium thereof) a mapping between objects in the graphical representation of the 3D location and 3D objects in the 3D location. At 1408, the XR application, via control circuitry 1311, based on the mapping, identifies (e.g., via control circuitry of server/XR device/user device, etc.) a correspondence between a graphical object in the portion of the graphical representation and a 3D object in the 3D location. If the XR application determines, at 1410, that the object in the portion of the graphical representation and 3D object correspond, then processing may proceed to 1412. If the XR application determines at 1410, the object in the portion of the graphical representation and 3D object does not correspond, then processing reverts to 1408. At 1412, the XR application transmits, via the I/O path 1312, (e.g., via networking, Bluetooth, internal bus, wireless communication, wired communication, or any suitable digital communication medium thereof) a signal to cause an AR device at the 3D location to generate for display an augmentation for the 3D object in the 3D location.

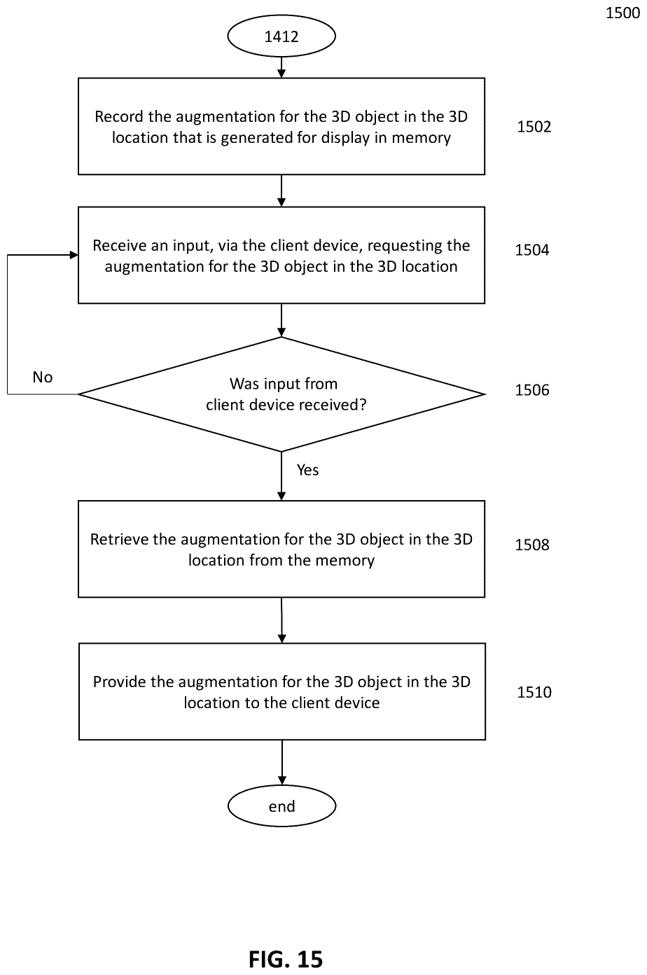

FIG. 15 is a flowchart of a detailed illustrative process 1500 for providing the augmentation for the 3D object in the 3D location to the client device, in accordance with some embodiments of this disclosure. At 1502, the XR application, via control circuitry 1311, records the augmentation for the 3D object in the 3D location that is generated for display in memory (e.g., embedded memory, flash memory, and/or any other suitable memory either local or remotely accessible via networking interface). At 1504, the XR application, via the I/O path 1312, receives an input (e.g., via touchscreen, keyboard, voice, gesture, instruction, code, eye gaze, etc.), via the client device (e.g., user equipment 1307, 1308, 1310), requesting the augmentation for the 3D object in the 3D location. If the XR application determines, at 1506, an input from the client device was received, then processing may proceed to 1508. If the XR application determines, at 1506, an input from the client device was not received, then processing reverts to 1504. At 1508, the XR application retrieves the augmentation, via storage 1314 and/or via I/O path 1312, for the 3D object in the 3D location from the memory (e.g., embedded memory, flash memory, and/or any other suitable memory either local or remotely accessible via networking interface). At 1510, the XR application provides, via the I/O path 1312, (e.g., via networking, Bluetooth, internal bus, wireless communication, wired communication, or any suitable digital communication medium thereof) the augmentation for the 3D object in the 3D location to the client device.

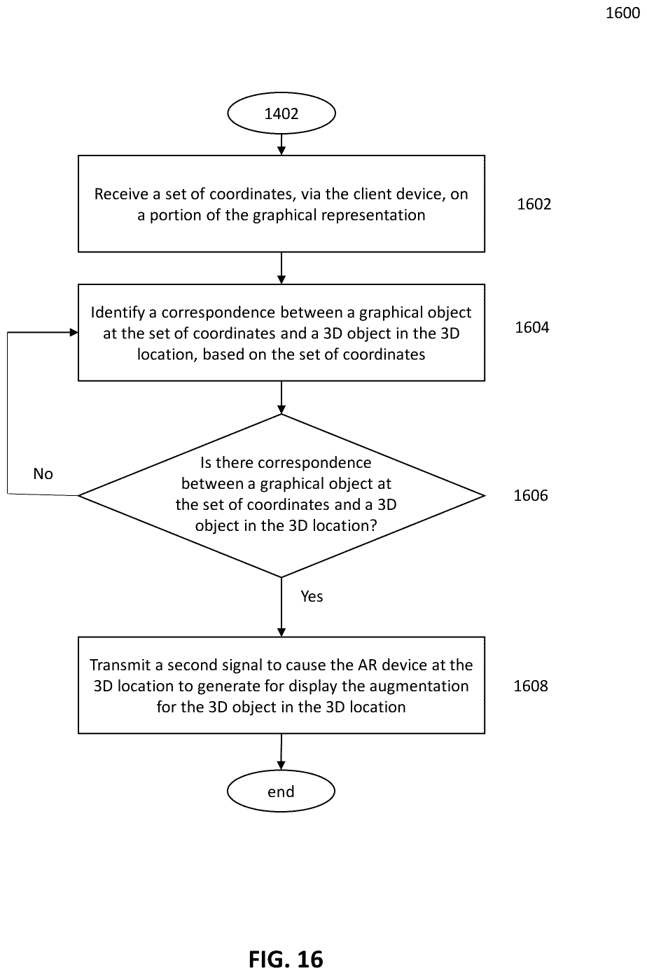

FIG. 16 is a flowchart of a detailed illustrative process 1600 for transmitting a second signal to cause the AR device at the 3D location to generate for display the augmentation for the 3D object in the 3D location, in accordance with some embodiments of this disclosure. At 1602, the XR application receives, via the I/O path 1312, (e.g., via networking, Bluetooth, internal bus, wireless communication, wired communication, or any suitable digital communication medium thereof) a set of coordinates (e.g., a dataset), via the client device (e.g., user equipment 1307, 1308, 1310), on a portion of the graphical representation. At 1604, the XR application identifies, via control circuitry 1311, a correspondence between a graphical object at the set of coordinates and a 3D object in the 3D location, based on the set of coordinates. If the XR application determines, at 1606, there is correspondence between a graphical object at the set of coordinates and a 3D object in the 3D location, then processing may proceed to 1608. If the XR application determines, at 1606, there is not correspondence between a graphical object at the set of coordinates and a 3D object in the 3D location, then processing reverts to 1604. At 1608, the XR application transmits, via the I/O path 1312, (e.g., via networking, Bluetooth, internal bus, wireless communication, wired communication, or any suitable digital communication medium thereof) a second signal to cause the AR device at the 3D location to generate for display (e.g., via GUI) the augmentation for the 3D object in the 3D location.

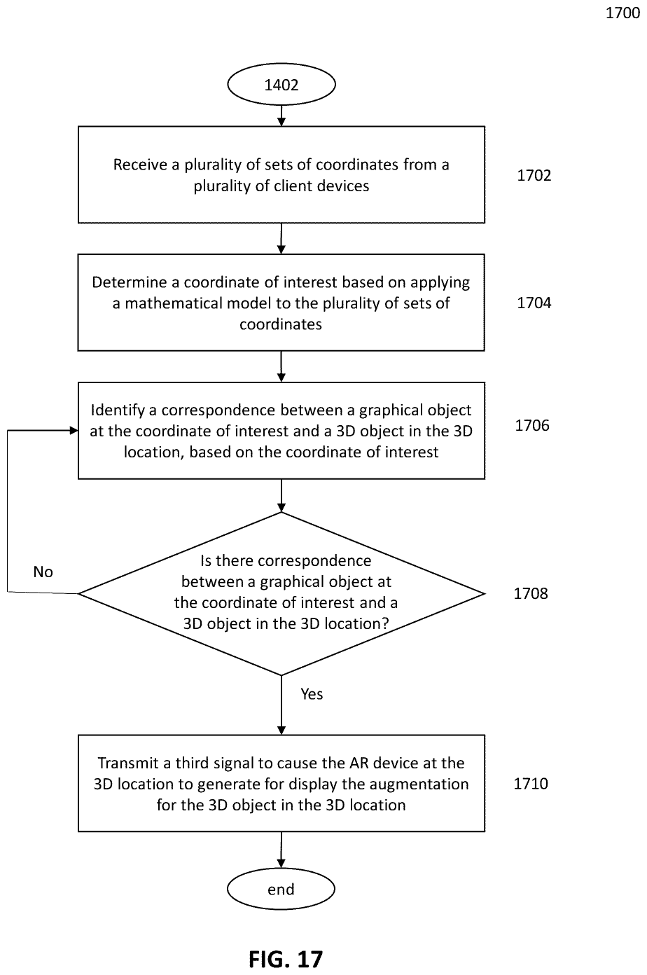

FIG. 17 is a flowchart of a detailed illustrative process 1700 for transmitting a third signal to cause the AR device at the 3D location to generate for display the augmentation for the 3D object in the 3D location, in accordance with some embodiments of this disclosure. At 1702, the XR application receives, via the I/O path, (e.g., via networking, Bluetooth, internal bus, wireless communication, wired communication, or any suitable digital communication medium thereof) a plurality of sets of coordinates (e.g., datasets) from a plurality of client devices (e.g., user equipment 1307, 1308, 1310). At 1704, the XR application determines, via control circuitry 1311, a coordinate of interest based on applying a mathematical model to the plurality of sets of coordinates. At 1706, the XR application identifies, via control circuitry 1311, a correspondence between a graphical object at the coordinate of interest and a 3D object in the 3D location, based on the coordinate of interest. If the XR application determines at 1708, there is correspondence between a graphical object at the coordinate of interest and a 3D object in the 3D location, then processing may proceed to 1710. If the XR application determines, at 1708, there is not a correspondence between a graphical object at the coordinate of interest and a 3D object in the 3D location, then processing reverts to 1706. At 1710, the XR application transmits, via the I/O path 1312 (e.g., via networking, Bluetooth, internal bus, wireless communication, wired communication, or any suitable digital communication medium thereof) a third signal to cause the AR device at the 3D location to generate for display (e.g., via GUI) the augmentation for the 3D object in the 3D location.

The processes discussed above are intended to be illustrative and not limiting. One skilled in the art would appreciate that the steps of the processes discussed herein may be omitted, modified, combined and/or rearranged, and any additional steps may be performed without departing from the scope of the invention. More generally, the above disclosure is meant to be illustrative and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. A method comprising:
generating for display on a client device a graphical representation of a 3D location;
receiving an input, via the client device, identifying a portion of the graphical representation;
accessing a mapping between objects in the graphical representation of the 3D location and 3D objects in the 3D location;
based on the mapping, identifying a correspondence between a graphical object in the portion of the graphical representation and a 3D object in the 3D location; and
transmitting a signal to cause an extended reality (XR) device at the 3D location to generate for display an augmentation for the 3D object in the 3D location.

2. The method of claim 1, wherein the graphical representation comprises a 2D graphical representation of the 3D location on the client device; and
wherein the identifying the correspondence further comprises, based on the mapping, identifying a correspondence between the graphical object in the portion of the 2D graphical representation and the 3D object in the 3D location.

3. The method of claim 1, wherein the graphical representation comprises a 3D graphical representation of the 3D location on the client device; and
wherein the identifying the correspondence further comprises, based on the mapping, identifying a correspondence between the graphical object in the portion of the 3D graphical representation and the 3D object in the 3D location.

4. The method of claim 1, wherein the generating for display the augmentation for the 3D object in the 3D location comprises generating for display at least one of: an indicator that appears proximate to the 3D object, highlighting that appears overlaid over the 3D object, an overlay proximate to the 3D object, and a messaging interface proximate to the 3D object.

5. The method of claim 1, wherein the identifying correspondence between an object in the portion of the graphical representation and the 3D object in the 3D location is performed by a server not local to the client device or the XR device.

6. The method of claim 1, further comprising:
creating on the XR device the graphical representation of the 3D location;
storing the graphical representation of the 3D location in memory;
receiving an input, via the client device, requesting the graphical representation of the 3D location; and
in response to receiving the input requesting the graphical representation of the 3D location:
retrieving the graphical representation of the 3D location from the memory; and
providing the graphical representation of the 3D location to the client device.

7. The method of claim 1, further comprising:
recording the augmentation for the 3D object in the 3D location that is generated for display in memory;
receiving an input, via the client device, requesting the augmentation for the 3D object in the 3D location; and
in response to receiving the input requesting the augmentation for the 3D object in the 3D location:
retrieving the augmentation for the 3D object in the 3D location from the memory; and
providing the augmentation for the 3D object in the 3D location to the client device.

8. The method of claim 1, further comprising:
receiving a set of coordinates, via the client device, on a portion of the graphical representation;
based on the set of coordinates, identifying a correspondence between a graphical object at the set of coordinates and a 3D object in the 3D location; and
transmitting a second signal to cause the XR device at the 3D location to generate for display the augmentation for the 3D object in the 3D location.

9. The method of claim 8, wherein the set of coordinates is received by at least one of: a mouse click, a selection, a touch on a touchscreen, and a point of interest based on eye gaze.

10. The method of claim 8, wherein:
the receiving the set of coordinates further comprises receiving a plurality of sets of coordinates from a plurality of client devices;
determining a coordinate of interest based on applying a mathematical model to the plurality of sets of coordinates;
based on the coordinate of interest, identifying a correspondence between a graphical object at the coordinate of interest and a 3D object in the 3D location; and
transmitting a third signal to cause the XR device at the 3D location to generate for display the augmentation for the 3D object in the 3D location.

11. A system comprising:
control circuitry configured to:
generate for display on a client device a graphical representation of a 3D location;
receive an input, via the client device, identifying a portion of the graphical representation;
access a mapping between objects in the graphical representation of the 3D location and 3D objects in the 3D location;
based on the mapping, identify a correspondence between a graphical object in the portion of the graphical representation and a 3D object in the 3D location; and
transmit a signal to cause an extended reality (XR) device at the 3D location to generate for display an augmentation for the 3D object in the 3D location.

12. The system of claim 11, wherein the graphical representation comprises a 2D graphical representation of the 3D location on the client device; and
wherein the control circuitry is further configured, when based on the mapping, to identify a correspondence between the graphical object in the portion of the 2D graphical representation and the 3D object in the 3D location.

13. The system of claim 11, wherein the graphical representation comprises a 3D graphical representation of the 3D location on the client device; and
wherein the control circuitry is further configured, when based on the mapping, to identify a correspondence between the graphical object in the portion of the 3D graphical representation and the 3D object in the 3D location.

14. The system of claim 11, wherein the generating for display the augmentation for the 3D object in the 3D location comprises generating for display at least one of: an indicator that appears proximate to the 3D object, highlighting that appears overlaid over the 3D object, an overlay proximate to the 3D object, and a messaging interface proximate to the 3D object.

15. The system of claim 11, wherein the identifying correspondence between an object in the portion of the graphical representation and the 3D object in the 3D location is performed by a server not local to the client device or the XR device.

16. The system of claim 11, wherein the control circuitry is further configured to:
create on the XR device the graphical representation of the 3D location;
store the graphical representation of the 3D location in memory;
receive an input, via the client device, requesting the graphical representation of the 3D location; and
in response to receiving the input requesting the graphical representation of the 3D location, the control circuitry is configured to:
retrieve the graphical representation of the 3D location from the memory; and
provide the graphical representation of the 3D location to the client device.

17. The system of claim 11, wherein the control circuitry is further configured to:
record the augmentation for the 3D object in the 3D location that is generated for display in memory;
receive an input, via the client device, requesting the augmentation for the 3D object in the 3D location; and
in response to receiving the input requesting the augmentation for the 3D object in the 3D location, the control circuitry is configured to:
retrieve the augmentation for the 3D object in the 3D location from the memory; and
provide the augmentation for the 3D object in the 3D location to the client device.

18. The system of claim 11, wherein the control circuitry is further configured to:
receive a set of coordinates, via the client device, on a portion of the graphical representation;
based on the set of coordinates, identify a correspondence between a graphical object at the set of coordinates and a 3D object in the 3D location; and
transmit a second signal to cause the XR device at the 3D location to generate for display the augmentation for the 3D object in the 3D location.

19. The system of claim 18, wherein the set of coordinates is received by at least one of: a mouse click, a selection, a touch on a touchscreen, and a point of interest based on eye gaze.

20. The system of claim 18, wherein:
the receiving the set of coordinates further comprises the control circuitry to receive a plurality of sets of coordinates from a plurality of client devices;
the control circuitry is configured to determine a coordinate of interest based on applying a mathematical model to the plurality of sets of coordinates;
based on the coordinate of interest, the control circuitry is configured to identify a correspondence between a graphical object at the coordinate of interest and a 3D object in the 3D location; and
the control circuitry is configured to transmit a third signal to cause the XR device at the 3D location to generate for display the augmentation for the 3D object in the 3D location.

21-50. (canceled)
